(19) United States
(12) Patent Application Publication
(10) Pub. No.: US 2010/0114377 A1
(43) Pub. Date: May 6, 2010

(54) Air conditioning device for switchgear cabinets

(75) Inventors: Michael Rudi Seifert, Madliena (MT); Keith Patrick Zammit, Safi (MT); Leo Hirth, Gharghur (MT)

Correspondence Address: BODNER & O'ROURKE, LLP, 425 BROADHOLLOW ROAD, SUITE 108, MELVILLE, NY, 11747, US

(73) Assignee: Seifert mtm Systems Malta Ltd., Malta (MT)

(21) Appl. No.: 12/321,317

(22) Filed: Jan. 16, 2009

(30) Foreign Application Priority Data
Oct. 31, 2008 (DE) 10 2008 054 081.1

(51) Int. Cl. G05B 15/00; F25B 1/00; F25D 17/06

(52) U.S. Cl. 700/275; 62/498; 62/426

(57) ABSTRACT

The invention relates to an air conditioning device for switchgear cabinets, wherein the air conditioning device, which is located in a case, is arranged in constructional proximity to a switchgear cabinet and an air circulation between the switchgear cabinet and the air conditioning device is allowed by means of openings directed to the switchgear cabinet. According to the invention the air conditioning device can be operated in three different modes, which allow an active cooling, a passive cooling and a heating of the circulating air.

The invention relates to an air conditioning device for switchgear cabinets, wherein the air conditioning device, which is located in a case, is arranged in constructional proximity to a switchgear cabinet and an air circulation between the cabinet and the air conditioning device is allowed by means of openings directed to the switchgear cabinet, according to the preamble of claim 1.

A plurality of air conditioning systems and apparatus are known from the prior art, the cooling of which is based on different physical principles. In addition, various air conditioning control systems are provided.

The utility model document DE 201 05 487 U1 discloses a cooling apparatus, which can be operated in various modes to optimize the effectiveness. The air conditioning of rooms, and specifically of switchgear cabinets, is performed on the basis of Peltier elements, wherein the cooling apparatus is comprised of a heat exchanger subject to forced air circulation, which is provided on the inside and the outside of the room to be air-conditioned, and of Peltier elements disposed therebetween. The cooling apparatus can be operated in three different cooling modes, wherein the interconnection of the Peltier elements is changed with respect to each other for each single mode, and the cooling apparatus is provided with at least four individually interconnectable Peltier units, and wherein the switching between the individual cooling modes is performed in dependence on the ambient temperature.

A plurality of prior air conditioning systems for switchgear cabinets are operated on the basis of compressor-generated cooling. The compressor is controlled either in dependence on the temperature or in dependence on temperature and time, wherein, when the compressor has reached predetermined temperature values, it is switched off and on. In a combination with a time-dependent control, the on-off switching procedure of the compressor takes place in dependence on the temperature values inside the switchgear cabinet and, at the same time, after certain time intervals have expired. On the one hand, this results in higher switching rates, so that the compressor is switched off more frequently as compared to the pure temperature-dependent control, but simultaneously also leads to higher temperature variations in the interior of a switchgear cabinet because the compressor can react on changed temperature conditions only after the expiry of a time interval. This leads to an excessively high rise or drop of the temperatures in the interior of the cabinet. At the same time, the compressor, when controlled in such a way, is switched on and off so frequently that the service life of the compressor and the hose system connected to the compressor is reduced due to the permanent rotary forces. If the compressor is switched on and off frequently and is operated at a maximum level, the average service life of a compressor of approximately 10 years is reduced to 2 years.

In document DE 692 23 460 T2 an operation control unit for air conditioning apparatus is described, said apparatus comprising a compressor which can be operated intermittently and has a variable operating frequency. The operation control is adjusted in such a way that a provided device reacts on a difference between the ambient temperature and a set temperature so as to control the operating frequency of the compressor to reduce the temperature difference and stop the compressor when the air conditioning load is smaller than the capacity of the air conditioning apparatus at a minimum value of the operating frequency.

According to another embodiment of the invention there is provided a compressor driven by an inverter and a control device, which varies the minimum operating frequency of the compressor on the basis of the outside air temperature. Consequently, a cost-effective operation with the same capacity can be achieved.

To achieve a continuous air conditioning with a maximum efficiency, a third embodiment includes a device for calculating the operating condition of a compressor, which not only serves to select the minimum frequency, but also to correct the selected minimum frequency, so that the operating condition can be optimized with respect to the minimum frequency. Consequently, not only minimum frequencies can be set, which provide for optimum efficiencies in correspondence with different operating conditions, but it is also possible to maintain operating conditions suited for the respective operating frequency, so as to prevent the deterioration of the efficiency as a result of a reduction of the operating conditions.

Especially if electric and electronic components are located in switchgear cabinets, it is of utmost significance with respect to the service life and the failure quota of the components that these are exposed to a constant temperature. Switchgear cabinets can be located inside and outside buildings. Switchgear cabinets for mobile radio systems are mounted, for example, on the roofs of houses and are exposed to seasonal temperature variations between −20° C. and +50° C. Irrespective of these temperatures, the components provided in the switchgear cabinets should be exposed, according to manufacturer's data, to a constant temperature.

Based on the foregoing it is, therefore, the object of the present invention to provide an air conditioning device for switchgear cabinets, which allows a constant temperature inside the switchgear cabinets and which simultaneously reduces the operating expenses for such air conditioning devices to a minimum. Moreover, the novel device is to allow a careful operation of the cooling compressor used and, consequently, a prolonged service life.

The solution to the object of the invention is achieved with an air conditioning device for switchgear cabinets according to the preamble of claim 1. The dependent claims describe at least expedient embodiments and advancements.

At first, an air conditioning device for switchgear cabinets is assumed, which is located in a case. This case is arranged in constructional proximity to a switchgear cabinet. An air circulation between the switchgear cabinet and the air conditioning device is allowed by means of openings directed to the switchgear cabinet.

According to the invention, the air conditioning device can be operated in three different operating modes. Provided are an active cooling, a passive cooling and a heating of the circulating air.

The different operating modes are activated in dependence on the temperatures prevailing in the switchgear cabinet. To this end, a temperature sensor is necessary to allow the detection of occurring temperature differences. If the electric or electronic components provided in the switchgear cabinet are exposed to harmful high inside temperatures, the active cooling mode is activated.

The active cooling is realized by means of a known cooling generated by means of a compressor. To this end, a compressor, a condenser and an evaporator are necessary.

The air heated by the switchgear cabinet flows through an opening in the upper portion of the side of the case of the air conditioning device facing the switchgear cabinet into the case. At the same time, the cooling air necessary for the compressor-generated cooling is transported by an AC-powered fan in the lower portion of the side facing away from the switchgear cabinet through a cooling air inlet opening into the case of the air conditioning device.

Expediently, the cooling air inlet opening is provided with a metallic mesh filter so as to filter the dust particles contained in the cooling air.

In the compressor, the gaseous refrigerant is initially heated very strongly as result of the compression. The gaseous refrigerant is transported to the condenser, where the compression heat received in the condenser is dissipated to the ambience. In addition, the energy heat released during the condensation is dissipated. In this way, the refrigerant exits the condenser in a liquid state and is transported in the direction of the evaporator. The dissipated compression heat and energy heat exit the air conditioning case through an opening above the cooling air opening.

The air transported from the switchgear cabinet into the case of the air conditioning device is transported by means of a DC-powered fan to the evaporator, where the liquid refrigerant coming from the condenser evaporates under the given conditions, wherein the evaporator extracts heat from the air coming from the switchgear cabinet, thereby cooling the air.

After this procedure, the cooled air is transported through an opening on the side facing the switchgear cabinet into the switchgear cabinet. This described cycle is subsequently repeated.

According to the invention a speed-variable compressor is used for the above-described compressor-generated cooling. By this, the compressor need not always be switched on and off again, as was described above. The compressor speed is controlled in dependence on the temperature in the switchgear cabinet interior. Unnecessary on-off switching cycles are avoided, and the service life of the compressor is prolonged. In addition, a constant interior temperature of the switchgear cabinet is generated. The use of an inventive air conditioning device for cooling a switchgear cabinet, comprising a speed-variable compressor, brings about an energy efficiency.

In another embodiment of the present invention it is provided that the AC-powered fan, which is used for the transport of the cooling air into the case of the air conditioning device, is a speed-controlled fan.

The fan is controlled to realize a constant temperature difference between the ambient temperature and the condensation temperature. This results in a lower power consumption of the compressor. Aside from the reduced noise, a speed-controlled fan constitutes another energy-saving potential.

If the temperatures in the switchgear cabinet are so low that they would cause damage to the electric or electronic components in the long run, the mode “heating” is activated.

In this mode, the cold air emitted by the switchgear cabinet to the air conditioning device is, again, transported to the compressor zone. There, an AC-powered heating device is provided, which heats the cold air. As was already described in connection with the active cooling mode, the airflow is generated by a DC-powered fan.

The heated air exits the air conditioning device through the opening already known from the active cooling mode, which is provided on the side of the case facing the switchgear cabinet.

At extremely low ambient temperatures in combination with warm interior temperatures of the switchgear cabinet, or in the event of alarm conditions in the switchgear cabinet, it is possible to activate the passive cooling mode. If this mode is activated, a damper flap inventively provided in the case of the air conditioning device is activated, so that the same adopts a position that allows a direct cooling of the switchgear cabinet with the ambient air. In the operating modes active cooling and heating, the damper flap adopts a vertical blocking position, so that no untreated ambient air can flow into the air conditioning device. If the passive cooling mode is applied, the damper flap is driven by a DC- or AC-powered motor and brought into a horizontal position.

As a result thereof, the heated air emitted by the switchgear cabinet can be transported through a first opening in the case of the air conditioning device, which is provided in the uppermost portion of the side of the case facing away from the switchgear cabinet, out of the interior of the case, and cold ambient air (cooling air) can simultaneously be transported into the air conditioning case through a second opening provided underneath.

Expediently, the second opening is provided with a pleated HEPA (High Efficiency Particulate Airfilter) filter so as to filter dust particles from the ambient air.

By means of a DC-powered fan the cool ambient air is transported in the direction of the evaporator, wherein the known outlet opening for the cooling air is provided.

The operating mode described constitutes another possibility to use the compressor in a careful manner, or to use it as rarely as possible, respectively, thereby saving energy.

The air conditioning device according to the invention further comprises an emergency power system, which is preferably provided in form of batteries.

In another embodiment, all or individual fans of the air conditioning device are designed as speed-controlled fans.

At the initial start-up of the air conditioning device or the compressor-generated cooling, respectively, it is provided to initially operate the compressor at a low speed. This means that the speed is initially restricted and can, after the device was “started up”, be increased in steps. By means of this approach, suddenly occurring current consumption peaks are avoided.

Additionally, the air conditioning device comprises a hydrogen or a gas level sensor, so as to activate the passive cooling mode if the limit value with respect to the present hydrogen or other gaseous substances is exceeded. Upon the activation of the mode, the damper flap is brought into a horizontal position, so that the air present in the switchgear cabinet and in the air conditioning case can flow to the outside together with the harmful substances and fresh ambient air can flow into the air conditioning device.

In another embodiment of the present invention a fire or smoke sensor is provided. In the event of a fire or smoke development, the damper flap is brought into a vertical position first, should the same be in a horizontal position. Thus, it is prevented that fresh air possibly even promotes a fire or smoke development. Moreover, all fans and components of the air conditioning device are put out of operation, so as to smother the fire and prevent the flames and smoke from spreading.

The air conditioning device according to the invention is constructed to allow several connected air conditioning devices to be put into operation. If several devices are employed, one air conditioning device represents the master air conditioning device, which determines the operating mode for the remaining slave air conditioning devices.

Below, the invention shall be explained in more detail by means of several embodiments and with the aid of figures.

In the figures:

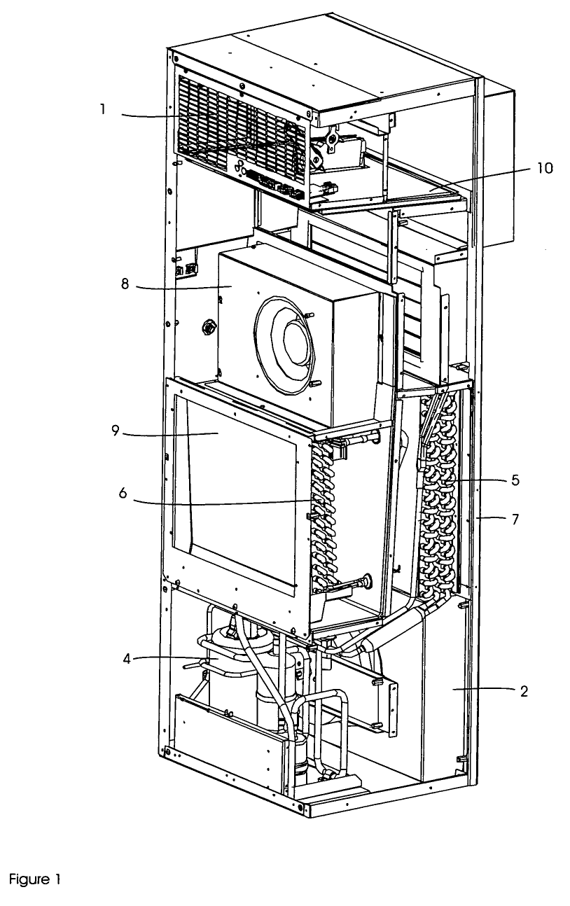

FIG. 1 shows a three-dimensional representation of the air conditioning device according to the invention;

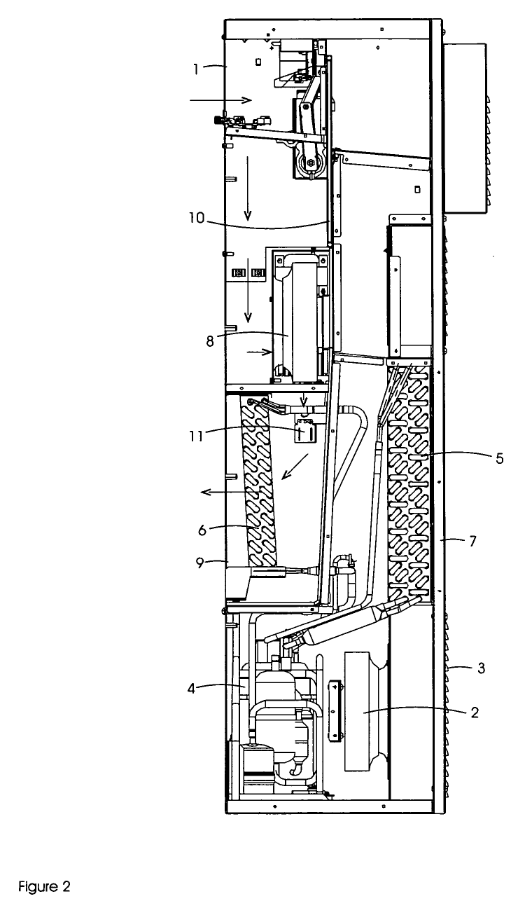

FIG. 2 shows a representation of the air conditioning device with the damper flap being closed; and

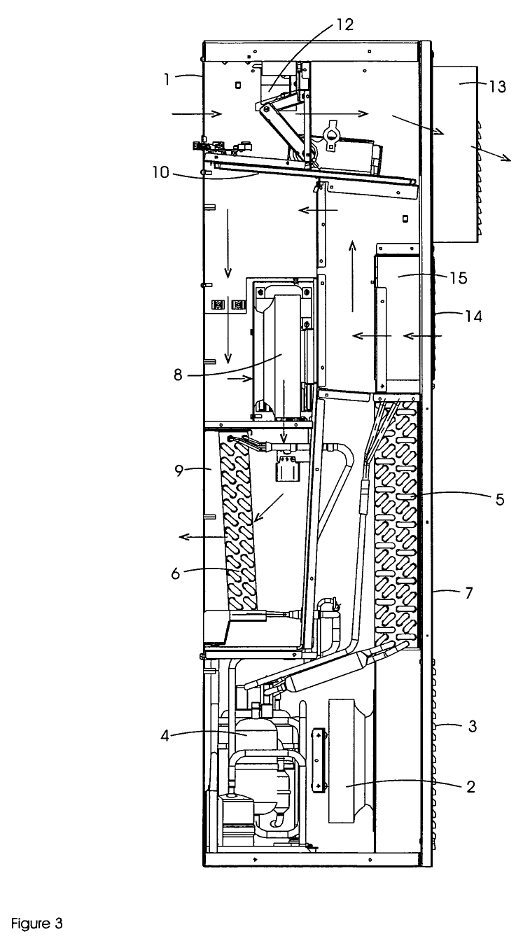

FIG. 3 shows a representation of the air conditioning device with the damper flap being opened.

As is shown in FIG. 1, the air conditioning device is located in a case, which has two openings on the side facing the switchgear cabinet. Thus, a circulating airflow can be generated, which is transported back and forth between the switchgear cabinet to be air-conditioned and the air conditioning device.

The air to be cooled or heated initially enters through an opening 1 in the upper portion of the air conditioning case. At the same time, the cooling air necessary for the compressor-generated cooling is transported by an AC-powered fan 2 in the lower portion of the side facing away from the switchgear cabinet through a cooling air inlet opening 3 into the case of the air conditioning device.

The cooling air inlet opening is provided with a metallic mesh filter so as to filter the dust particles contained in the cooling air.

In the speed-variable compressor 4 the gaseous refrigerant is initially heated very strongly by the compression. The gaseous refrigerant is transported to the condenser 5, where the compression heat received in the condenser 5 is dissipated to the ambience.

The refrigerant exits the condenser 5 in a liquid state and is transported in the direction of the evaporator 6. The dissipated compression heat and energy heat exit the air conditioning case through an opening 7 above the cooling air opening 3.

The air transported from the switchgear cabinet into the case of the air conditioning device is transported by means of a DC-powered fan 8 to the evaporator 6, where the liquid refrigerant coming from the condenser 5 evaporates under the given conditions, wherein the evaporator 6 extracts heat from the air coming from the switchgear cabinet, thereby cooling the air.

After this procedure, the cooled air is transported through an opening 9 on the side facing the switchgear cabinet into the switchgear cabinet. This described cycle is subsequently repeated.

In this embodiment, the fan 2 is constructed as a speed-controlled fan. The fan 2 is controlled to realize a constant temperature difference between the ambient temperature and the condensation temperature. This results in a reduced condensation pressure and, consequently, a lower power consumption of the speed-variable compressor 4.

In FIG. 2, the air conditioning device according to the invention is shown with the damper flap 10 being closed. The damper flap 10 is closed during the active cooling and heating modes. The arrows represented in FIG. 2 show the airflow during the heating mode. The air flows through the case opening 1 into the air conditioning device and is transported by the fan 8 in the direction of the evaporator 6. In this area a heating device 11 is provided, which heats the flow of air. The heated air exits the air conditioning device through the case opening 9 and is transported back into the switchgear cabinet.

In FIG. 3, the air conditioning device is shown with the damper flap 10 being opened. The damper flap 10 adopts this position, for example, in the passive cooling operating mode or if possible troubles occur. The damper flap 10 is driven by a motor 12. The arrows represented show the airflow during the passive cooling operating mode. The air flowing out of the switchgear cabinet is initially transported through the case opening 1 into the air conditioning device. Due to the horizontal position of the damper flap 10 the access to the fan 8 is blocked, so that the air flows in the direction of the case opening 13, and there out of the air conditioning device.

At the same time, cool ambient air flows through a cooling air inlet opening 14 on the side of the air conditioning case facing away from the switchgear cabinet into the device, wherein the ambient air first has to pass through a HEPA-filter 15. The purified air then flows into a chamber, and from there in the direction of the known fan 8.

Through the case opening 9 of the air conditioning device the cool and filtered ambient air is emitted into the switchgear cabinet.

### LIST OF REFERENCE NUMBERS

1 case opening
2 fan
3 cooling air inlet opening
4 speed-variable compressor
5 condenser
6 evaporator
7 case opening for dissipating the compression heat
8 fan
9 case opening for emitting the air-conditioned air
10 damper flap
11 heating device
12 damper flap motor
13 case opening for emitting the air transported out of the switchgear cabinet
14 cooling air inlet opening
15 HEPA-filter

1. Air conditioning device for switchgear cabinets, wherein the air conditioning device, which is located in a case, is arranged in constructional proximity to a switchgear cabinet and an air circulation between the switchgear cabinet and the air conditioning device is allowed by means of openings directed to the switchgear cabinet,
characterized in that
the air conditioning device can be operated in three different modes allowing an active cooling, a passive cooling and heating of the circulating air.

2. Air conditioning device according to claim 1,
characterized in that
if electric or electronic components provided in the switchgear cabinet are exposed to a harmful high inside temperature, the active cooling mode is activated.

3. Air conditioning device according to claim 1,
characterized in that
the active cooling is realized by means of a compressor-generated cooling, using a compressor (4), a condenser (5) and an evaporator (6).

4. Air conditioning device according to claim 3,
characterized in that
a speed-variable compressor (4) is used.

5. Air conditioning device according to claim 4,
characterized in that
the compressor speed of the device is controlled in dependence on the temperature of the switchgear cabinet interior.

6. Air conditioning device according to claim 3,
characterized in that
the necessary evaporator airflow is generated by a DC-powered fan (8).

7. Air conditioning device according to claim 3,
characterized in that
the necessary condenser airflow is generated by an AC-powered fan (2).

8. Air conditioning device according to claim 7,
characterized in that
the fan (2) is a speed-controlled fan.

9. Air conditioning device according to claim 8,
characterized in that
the fan (2) is controlled to realize a constant temperature difference between the ambient temperature and the condensation temperature.

10. Air conditioning device according to claim 1,
characterized in that
the ambient air necessary for the compressor-generated cooling flows through a cooling air inlet opening (3) into the device case.

11. Air conditioning device according to claim 10,
characterized in that
the cooling air inlet opening (3) is provided with a metallic mesh filter

12. Air conditioning device according to claim 1,
characterized in that
if electric or electronic components provided in the switchgear cabinet are exposed to a harmful low inside temperature, the heating mode is activated.

13. Air conditioning device according to claim 1,
characterized in that
in the heating mode, the airflow present in the air conditioning device is heated by an AC-powered heating device (11) and is transported through an opening (9) facing the switchgear cabinet to the switchgear cabinet.

14. Air conditioning device according to claim 13,
characterized in that
the airflow is generated by a DC-powered fan (8).

15. Air conditioning device according to claim 1,
characterized in that
at extremely low ambient temperatures or in the event of alarm conditions in the switchgear cabinet the passive cooling mode is activated.

16. Air conditioning device according to claim 1,
characterized in that
upon activating the passive cooling mode a damper flap (10) provided in the case of the air conditioning device is activated and adopts a position so as to realize a direct cooling of the switchgear cabinet with the ambient air.

17. Air conditioning device according to claim 16,
characterized in that
the damper flap (10) is driven by a DC-powered or AC-powered motor (12).

18. Air conditioning device according to claim 16,
characterized in that
the airflow is generated by a DC-powered fan (8).

19. Air conditioning device according to claim 16,
characterized in that
the cooling air inlet opening (14) is provided with a pleated HEPA-filter (15).

20. Air conditioning device according to claim 16,
characterized in that
in the active cooling and heating modes the damper flap (10) adopts a blocking position so that no untreated ambient air can flow into the air conditioning device.

21. Air conditioning device according to claim 1,
characterized in that
the device includes an emergency power system.

22. Air conditioning device according to claim 21,
characterized in that
the emergency power system is represented by batteries.

23. Air conditioning device according to claim 6,
characterized in that
the fan (8) is a speed-controlled fan.

24. Air conditioning device according to claim 3,
characterized in that
the compressor (4) is, upon its activation, initially operated at a low speed in order to increase the speed in steps subsequently.

25. Air conditioning device according to claim 1,
characterized in that
a hydrogen or gas level sensor is provided in the air conditioning device so as to activate the passive cooling mode if a limit value is exceeded.

26. Air conditioning device according to claim 1,
characterized in that
a fire or smoke sensor is provided in the air conditioning device so as to close the
damper flap (10) and switch off all fans and components in the event of a fire or smoke development.

27. Air conditioning device according to claim 1,
characterized in that
the air conditioning device is provided with an alarm system to output a warning signal if the operating temperatures are too high or too low, if components, the power supply or the heating function break down.

28. Use of several air conditioning devices according to claim 1
characterized in that
one of the air conditioning devices acts as a master air conditioning device and determines the operating mode of the slave air conditioning devices.
